(19) United States
(12) Patent Application Publication
(10) Pub. No.: US 2025/0274996 A1
(43) Pub. Date: Aug. 28, 2025

(54) METHOD AND APPARATUS FOR CONTROLLING A USER DEVICE

(71) Applicant: Nokia Technologies Oy, Espoo (FI)

(72) Inventors: Subramanya CHANDRASHEKAR, Bangalore (IN); Ömer BULAKCI, Munich (DE); Tero HENTTONEN, Espoo (FI); Ece GOSHI, Munich (DE); Suresh NAIR, Estero, FL (US)

(21) Appl. No.: 18/866,251

(22) PCT Filed: May 17, 2022
(86) PCT No.: PCT/EP2022/063229

§ 371 Date: Nov. 15, 2024

(51) Int. Cl. H04W 76/14; H04W 12/04; H04W 72/231

(52) U.S. Cl. CPC H04W 76/14; H04W 12/04; H04W 72/231

(57) ABSTRACT

Techniques for configuring an RRC connection including two RRC entities are provided. For example, a method of controlling a user device in a communications network is disclosed. The method comprises: receiving a message from a network node and configuring, at the user device, an RRC connection to the network node including selecting and/or determining either an RRC entity at a central unit control plane of the network node or an RRC entity at a local control plane of the network node for communication with or from the network node.

### TECHNICAL FIELD

The subject disclosure generally relates to wireless communication systems and more particularly, to wireless communication systems controlling a user device in a network.

### BACKGROUND

Wireless telecommunication systems are under constant development. There is a constant need for higher data rates and high quality of service. Reliability requirements are constantly rising and ways and means to ensure reliable connections and data traffic while keeping transmission delays minimal are constantly under development.

A disaggregated gNB (next Generation Node B) architecture was proposed decomposing the gNB into multiple logical entities. Such a disaggregated architecture is feasible for gNBs in 5G NR systems, for which the one or more first units may be represented by at least one distributed unit (DU) and the second unit may be represented by a centralized unit (CU). The CU may be further split into a CU Control Plane (CP) part, also referred to as CU-C or CU-CP, and a CU User Plane (UP) part, also referred to as CU-U or CU-UP. Such split enables the implementation of the CU-CP and CU-UP parts in different locations.

A DU may host multiple cells (max of 512 in current specifications). The gNB-CU-CP hosts one or more gNB-DUs and one or more gNB-CU-UP. There can be only one gNB-CU-CP in a gNB. The PDCP-C (control plane part) and RRC layers are in gNB-CU-CP, while the gNB-DU hosts the RLC, MAC and PHY layers. The scheduling operation takes place at the gNB-DU.

According to 3GPP RAN3, a 5G gNB should include only one gNB-CU-CP, “n” number of gNB-DUs controlled by a gNB-CU-CP, ‘m” number of gNB-CU-UP controlled by a gNB-CU-CP. One gNB-DU can be served by multiple gNB-CU-UP.

In case of 5G, the disaggregated architecture introduces node internal interfaces. This also introduces additional transport delays whenever there is signaling back and forth between the three different logical entities of the gNB. Since the user-plane is hosted in CU-UP and DU, it is quite natural for the signaling to involve back and forth signaling between these entities. This could imply that the signaling performance in 5G is worse than in 4G.

On a further dimension, one of the primary aspects of focus in the architectural evolution beyond 5G/6G is the RAN-CN unification (aka convergence). RAN-CN unification is trying to bring CN functions closer e.g.: PDU session characteristics may determine selection of a unified RAN-CN function or dedicated RAN, CN functions. Such unification may also lead to a higher aggregation for some of the RAN functions (than what exists in 5G) and this impacts RAN control-plane latency for delay-sensitive cases in a more detrimental way. 5G system architecture lacks the flexibility for RAN C-plane where such architectural evolutions can be addressed adequately.

### SUMMARY

According to a first aspect of the subject disclosure, a method of controlling a user device in a communications network is provided. The method according to the first aspect may be performed by the user device. The method comprises: receiving a message from a network node; configuring, at the user device, an RRC connection to the network node including selecting and/or determining either an RRC entity at a central unit control plane of the network node or an RRC entity at a local control plane of the network node for communication with or from the network node.

In some embodiments of the first aspect, the method may comprise selecting, by the user device, based on the indication a key corresponding to the selected RRC entity from a stored key set; and using, by the user device, the key to encrypt/decrypt or integrity protect/verify communication to/from the network node.

In some embodiments of the first aspect, the message may be a downlink RRC message including an indication of the RRC entity to select.

In some embodiments of the first aspect, a similar or identical indication may be included in UL RRC messages sent by the user device.

In some embodiments of the first aspect, the method may further comprise communicating with the local control plane for execution of intra-gNB functionality, like reporting layer1 and/or layer3 measurements to the network, receiving configurations related to cell access or executing mobility procedures like CHO or L1 based mobility handling, for forwarding of NAS messages to the central control plane, and/or for performing control plane functions at a user device level or DRB/PDU-session level.

In some embodiments of the first aspect, the method may further comprise communicating with the central unit control plane for overall connection control, for inter-NG RAN node, and/or inter-RAT procedures.

In some embodiments of the method according to the first aspect, the user device can receive RRC messages from the central unit control plane and the local control plane of the network node as part of the same RRC connection.

In some embodiments of the first aspect, the method may further comprise receiving an indication, from a network node, on provision of multiple local control planes for slice support; and sending, to the network node, an association of the user device with one or more of the multiple local control planes according to slice services.

According to a second aspect of the subject disclosure, a method of controlling a network device in a communications network is provided. The method according to the second aspect may be performed by one or more network nodes. The method comprises: sending a message to a user device; configuring an RRC connection to the user device including an RRC entity at a central unit control plane and an RRC entity at a local control plane of a network node, for transmission and reception of signaling messages with the network.

In some embodiments of the second aspect, the message may be a downlink message including an indication of the RRC entity to be selected for communication with the network.

In some embodiments of the second aspect, the indication of the RRC entity may be be selected is based on the type and/or capabilities of the user device and services invoked.

In some embodiments of the second aspect, the local control plane may be configured per a single user device or per a group of user devices like a Virtual Network, VN group.

In some embodiments of the method according to the second aspect, the local control plane provides RRC functionality, like providing user devices with configurations related to cell access or executing mobility procedures like CHO or L1 based mobility handling, forwarding of NAS messages received from user device to the central unit control plane, and/or performing control plane functions at a user device level or DRB/PDU-session level.

In some embodiments of the method according to the second aspect, the central unit control plane provides overall connection control and/or inter-NG RAN node and/or inter-RAT procedures.

In some embodiments of the method according to the second aspect, the RRC messages may be sent to the user device from the central unit control plane and/or the local control plane of the network node as part of the RRC connection.

In some embodiments of the method according to the second aspect, the RRC messages may be sent to the user device from the central unit control plane and the local control plane of the network node are associated and/or encrypted using different security keys.

In some embodiments of the method according to the second aspect, the security key associated with the local control plane may be generated by the central unit control plane and configured to both the user device and the local control plane.

In some embodiments of the method according to the second aspect, the local control plane entity may be enabled to be instantiated and associated with at least one gNB-DU of an NG-RAN node.

In some embodiments of the first aspect, the method may further comprise terminating, by the central unit control plane only, an interface with the core network.

In some embodiments of the first aspect, the method may further comprise deciding, by the central control unit plane only, on an RRC state of the user device.

In some embodiments of the first aspect, the method may further comprise storing context of the user device in the central unit control plane and/or the local control plane.

In some embodiments of the first aspect, the method may further comprise storing or reading, by the local control plane, context of the user device to or from a RAN data base.

In some embodiments of the first aspect, the method may further comprise storing context of the user device in a RAN data base.

In some embodiments of the first aspect, the method may further comprise providing one or more multiple local control planes for slice support; and receiving, from the user device, an association of the user device with one or more of the multiple local control planes according to slice services.

In some embodiments of the first aspect, the method may further comprise exchanging slice support information and/or slice-related parameters over an interface between the central unit control plane and/or the local control plane.

According to a third aspect of the subject disclosure, a user device is provided. The user device may comprise at least one processor; and at least one memory including computer program code. The computer program code causes the user device, when executed with the at least one processor, to at least: receive a message from a network node; configure an RRC connection to the network node including selecting and/or determining either an RRC entity at a central unit control plane of the network node or an RRC entity at a local control plane of the network node for communication with or from the network node.

In some embodiments of the third aspect, the computer program code may cause the user device, when executed with the at least one processor, to perform a method of controlling a user device in a communications network as described above.

According to a fourth aspect, a network device in a network is provided. The network device comprises at least one processor; and at least one memory including computer program code. The computer program code causes the network device, when executed with the at least one processor, to: receive a message from a user device; configuring an RRC connection to the user device including an RRC entity at a central unit control plane and an RRC entity at a local control plane of a network node, for transmission and reception of signaling messages with the network.

In some embodiments of the fourth aspect, the computer program code may cause the network device, when executed with the at least one processor, to perform a method of controlling a network device in a communications network as described above.

According to a fifth aspect of the subject disclosure, a user device is provided. The user device comprises means of receiving a message from a network node; and means of configuring an RRC connection to the network node including selecting and/or determining either an RRC entity at a central unit control plane of the network node or an RRC entity at a local control plane of the network node for communication with or from the network node.

In some embodiments of the fifth aspect, the computer program code may cause the user device, when executed with the at least one processor, to perform a method of controlling a user device in a communications network as described above.

According to a sixth aspect of the subject disclosure, a network device is provided. The network device comprises means of sending a message to a user device; and means of configuring an RRC connection to the user device including an RRC entity at a central unit control plane and an RRC entity at a local control plane of a network node, for transmission and reception of signaling messages with the network.

In some embodiments of the sixth aspect, the computer program code may cause the network device, when executed with the at least one processor, to perform a method of controlling a network device in a communications network as described above.

According to a seventh aspect of the subject disclosure, a non-transitory computer-readable media containing computer-executable instructions which when run on one or more processors perform steps according to any one of the embodiments of the methods outlined above when said program is executed on a computer.

The above-noted aspects and features may be implemented in systems, apparatuses, methods, articles and/or non-transitory computer-readable media depending on the desired configuration. The subject disclosure may be implemented in and/or used with a number of different types of devices, including but not limited to cellular phones, tablet computers, wearable computing devices, portable media players, and any of various other computing devices.

This summary is intended to provide a brief overview of some of the aspects and features according to the subject disclosure. Accordingly, it will be appreciated that the above-described features are merely examples and should not be construed to narrow the scope of the subject disclosure in any way. Other features, aspects, and advantages of the subject disclosure will become apparent from the following detailed description, drawings and claims.

### LIST OF ABBREVIATIONS

In the subject disclosure, the following abbreviations are used and should be understood in accordance with the given definitions:
3GPP 3^{rd} Generation Partnership Project
5G 5^{th} Generation (Mobile Communication Network)
5GC 5G Core
5GS 5G System
AF Application Function
AMF Access and Mobility Function
AN Access Network
APN Access Point Name
BS Base Station
CDMA Code Division Multiple Access
CN Core Network
CP Control Plane
DNN Data Network Name
eNB Evolved NodeB
EPC Evolved Packet Core
EPS Evolved Packet System
ETSI European Telecommunications Standards Institute
E-UTRAN Evolved UMTS Terrestrial Radio Access
IE Information Element
IMS IP Multimedia Subsystem
IP Internet Protocol
LTE Long Term Evolution
MME Mobility Management Entity
NAS Non-Access Stratum
NR New Radio
NSSAI Network Slice Selection Assistance Information
PDN Packet Data Network
PDP Packet Data Protocol
PGW PDN Gateway
PGW-C PGW Control Function
PLMN Public Land Mobile Network
RAN Radio Access Network
RCS Rich Communication Services
RRC Radio Resource Control (Protocol)
SGW Serving Gateway
SIM Subscriber Identity Module
SMF Session Management Function
S-NSSAI Single NSSAI
TS Technical Specification
UE User Equipment
URLLC Ultra-Reliable Low Latency Communication
VoNR Voice over NR

### BRIEF DESCRIPTION OF THE DRAWINGS

A better understanding of the subject disclosure can be obtained when the following detailed description of various embodiments is considered in conjunction with the following drawings, in which:

FIG. 1 shows a schematic diagram of an example communication system comprising a base station and a plurality of communication devices;

FIG. 2 shows a schematic diagram of an example mobile communication device;

FIG. 3 shows a schematic diagram of an example control apparatus;

FIG. 4 illustrates an example disaggregated gNB architecture including a local control plane;

FIG. 5 illustrates an example message sequence diagram for RRC connection setup;

FIG. 6 illustrates an example message sequence diagram for intra and inter-gNB hand over;

FIG. 7 illustrates an example flow chart of a method for controlling a user device in a network;

FIG. 8 illustrates an example flow chart of a method for controlling a network device in a network; and

FIG. 9 illustrates an example PDCP protocol data unit for a Signaling Radio Bearer.

### DETAILED DESCRIPTION

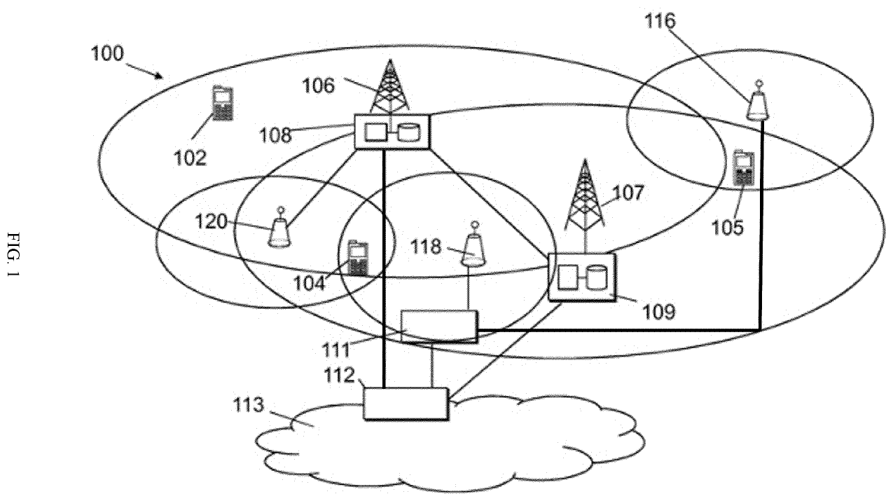

Before explaining the examples in detail, certain general principles of a wireless communication system and mobile communication devices are briefly explained with reference to FIGS. 1 to 3 to assist in understanding the technology underlying the described examples.

In a wireless communication system 100, such as that shown in FIG. 1, mobile communication devices, user devices, user equipment (UE) 102, 104, 105 are provided wireless access via at least one base station (e.g., next generation NB, gNB), similar wireless transmitting and/or receiving node or network node. Base stations may be controlled or assisted by at least one appropriate controller apparatus, so as to enable operation thereof and management of mobile communication devices in communication with the base stations. The controller apparatus may be located in a radio access network (e.g., wireless communication system 100) or in a core network (CN) (not shown) and may be implemented as one central apparatus or its functionality may be distributed over several apparatuses. The controller apparatus may be part of the base station and/or provided by a separate entity such as a Radio Network Controller (RNC). In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller.

In FIG. 1, base stations 106 and 107 are shown as connected to a wider communications network 113 via gateway 112. A further gateway function may be provided to connect to another network.

As used herein, the term “base station” has the full breadth of its ordinary meaning, and at least includes a wireless communication station installed at a fixed location and used to communicate as part of a wireless telephone system or radio system. The communication area (or coverage area) of the base stations may be referred to as a “cell.” The base stations and the UEs may be configured to communicate over the transmission medium using any of various radio access technologies (RATs), also referred to as wireless communication technologies, or telecommunication standards described hereinbelow. As illustrated in FIG. 1, while one of the base stations may act as a “serving cell” for UEs, each UE may also be capable of receiving signals from (and possibly within communication range of) one or more other cells (which might be provided by the base stations and/or any other base stations), which may be referred to as “neighboring cells”.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided. Smaller base stations 116, 118 and 120 may be part of a second network, for example, wireless local area network (WLAN) and may be WLAN access points (Aps). The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

An example of wireless communication systems are architectures standardized by the 3rd Generation Partnership Project (3GPP). A latest 3GPP based development is often referred to as the long-term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE (LTE-A) employs a radio mobile architecture known as the Evolved Universal Terrestrial Radio Access Network (E-UTRAN) and a core network known as the Evolved Packet Core (EPC). Base stations of such systems are known as evolved or enhanced Node Bs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other examples of radio access system comprise those provided by base stations of systems that are based on technologies such as WLAN and/or Worldwide Interoperability for Microwave Access (WiMax). A base station can provide coverage for an entire cell or similar radio service area. Core network elements include Mobility Management Entity (MME), Serving Gateway (S-GW) and Packet Gateway (P-GW).

An example of a suitable communications system is the 5G or NR concept. Network architecture in NR may be similar to that of LTE-A. Base stations of NR systems may be known as next generation Node Bs (gNBs). Changes to the network architecture may depend on the need to support various radio technologies and finer Quality of Service (QoS) support, and some on-demand requirements for e.g., QoS levels to support Quality of Experience (QoE) of user point of view. Also network aware services and applications, and service and application aware networks may bring changes to the architecture. Those are related to Information Centric Network (ICN) and User-Centric Content Delivery Network (UC-CDN) approaches. NR may use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

Future networks may utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the split and distribution of functionality between core network operations and base station operations may differ from that of the LTE or even be non-existent.

An example 5G core network (CN) comprises functional entities. The CN is connected to a UE via the radio access network (RAN). An UPF (User Plane Function) whose role is called PSA (PDU Session Anchor) may be responsible for forwarding frames back and forth between the DN (data network) and the tunnels established over the 5G towards the UEs exchanging traffic with the data network (DN).

The UPF is controlled by an SMF (Session Management Function) that receives policies from a PCF (Policy Control Function). The CN may also include an AMF (Access & Mobility Function).

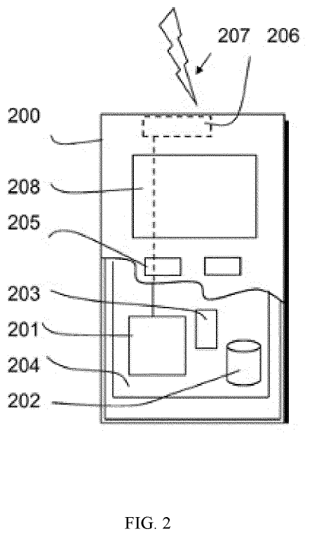

A possible (mobile) communication device 200 will now be described in more detail with reference to FIG. 2 showing a schematic, partially sectioned view. Such a mobile communication device 200 is often referred to as user equipment (UE), user device or terminal device. An appropriate mobile communication device 200 may be provided by any device capable of sending and receiving radio signals. Non-limiting examples comprise a mobile station (MS) or mobile device such as a mobile phone or what is known as a smart phone, a computer provided with a wireless interface card or other wireless interface facility (e.g., USB dongle), personal data assistant (PDA) or a tablet provided with wireless communication capabilities, or any combinations of these or the like. The communication device 200 may provide, for example, communication of data for carrying communications such as voice, electronic mail (e-mail), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

In an industrial application a communication device may be a modem integrated into an industrial actuator (e.g., a robot arm) and/or a modem acting as an Ethernet-hub that will act as a connection point for one or several connected Ethernet devices (which connection may be wired or unwired).

The communication device 200 is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets 204. The user may control the operation of the communication device 200 by means of a suitable user interface such as keypad 205, voice commands, touch sensitive screen or pad, combinations thereof or the like. A display 208, a speaker and a microphone can be also provided. Furthermore, the communication device 200 may comprise appropriate connectors (either wired or wireless) to other devices and/or for connecting external accessories, for example hands-free equipment, thereto.

The communication device 200 may receive signals over an air or radio interface 207 via appropriate apparatus for receiving and may transmit signals via appropriate apparatus for transmitting radio signals. In FIG. 2, transceiver apparatus is designated schematically by block 206. The transceiver apparatus 206 may be provided for example by means of a radio part and associated antenna arrangement. The antenna arrangement may be arranged internally or externally to the communication device 200.

The communication device 200 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

Generally, the communication device 200 illustrated in FIG. 2 includes a set of components configured to perform core functions. For example, this set of components may be implemented as a system on chip (SoC), which may include portions for various purposes. Alternatively, this set of components may be implemented as separate components or groups of components for the various purposes. The set of components may be coupled (e.g., communicatively; directly or indirectly) to various other circuits of the communication device 200.

The communication device 200 may include at least one antenna in communication with a transmitter and a receiver (e.g., the transceiver apparatus 206). Alternatively, transmit and receive antennas may be separate. The communication device 200 may also include a processor (e.g., the at least one data processing entity 201) configured to provide signals to and receive signals from the transmitter and receiver, respectively, and to control the functioning of the communication device 200. The processor may be configured to control the functioning of the transmitter and receiver by effecting control signaling via electrical leads to the transmitter and receiver. Likewise, the processor may be configured to control other elements of the communication device 200 by effecting control signaling via electrical leads connecting processor to the other elements, such as a display (e.g., display 208) or a memory (e.g., the at least one memory 202). The processor may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, in some examples, the processor may comprise a plurality of processors or processing cores.

The communication device 200 may be capable of operating with one or more air interface standards, communication protocols, modulation types, access types, and/or the like. Signals sent and received by the processor may include signaling information in accordance with an air interface standard of an applicable cellular system, and/or any number of different wireline or wireless networking techniques, comprising but not limited to Wi-Fi, WLAN techniques, such as Institute of Electrical and Electronics Engineers (IEEE) 802.11, 802.16, 802.3, ADSL, DOCSIS, and/or the like. In addition, these signals may include speech data, user generated data, user requested data, and/or the like.

For example, the communication device 200 and/or a cellular modem therein may be capable of operating in accordance with various third-generation (3G) communication protocols, fourth-generation (4G) communication protocols, fifth-generation (5G) communication protocols, Internet Protocol Multimedia Subsystem (IMS) communication protocols (for example, session initiation protocol (SIP) and/or the like), or 5G beyond. For example, the communication device 200 may be capable of operating in accordance with 4G wireless communication protocols, such as LTE Advanced, 5G, and/or the like as well as similar wireless communication protocols that may be subsequently developed.

It is understood that the processor may include circuitry for implementing audio/video and logic functions of the communication device 200. For example, the processor may comprise a digital signal processor device, a microprocessor device, an analog-to-digital converter, a digital-to-analog converter, and/or the like. Control and signal processing functions of the communication device 200 may be allocated between these devices according to their respective capabilities. The processor may additionally comprise an internal voice coder (VC), an internal data modem (DM), and/or the like. Further, the processor may include functionality to operate one or more software programs, which may be stored in memory. In general, the processor and stored software instructions may be configured to cause the communication device 200 to perform actions. For example, the processor may be capable of operating a connectivity program, such as a web browser. The connectivity program may allow the communication device 200 to transmit and receive web content, such as location-based content, according to a protocol, such as wireless application protocol (WAP), hypertext transfer protocol (HTTP), and/or the like.

The communication device 200 may also comprise a user interface including, for example, an earphone or speaker, a ringer, a microphone, a display, a user input interface, and/or the like, which may be operationally coupled to the processor. The display may, as noted above, include a touch sensitive display, where a user may touch and/or gesture to make selections, enter values, and/or the like. The processor may also include user interface circuitry configured to control at least some functions of one or more elements of the user interface, such as the speaker, the ringer, the microphone, the display, and/or the like. The processor and/or user interface circuitry comprising the processor may be configured to control one or more functions of one or more elements of the user interface through computer program instructions, for example, software and/or firmware, stored on a memory accessible to the processor, for example, volatile memory, non-volatile memory, and/or the like. The communication device 200 may include a battery for powering various circuits related to the mobile terminal, for example, a circuit to provide mechanical vibration as a detectable output. The user input interface may comprise devices allowing the communication device 200 to receive data, such as a keypad (e.g., keypad 206) and/or other input devices. The keypad can also be a virtual keyboard presented on display or an externally coupled keyboard.

The communication device 200 may also include one or more mechanisms for sharing and/or obtaining data. For example, the communication device 200 may include a short-range radio frequency (RF) transceiver and/or interrogator, so data may be shared with and/or obtained from electronic devices in accordance with RF techniques. The communication device 200 may include other short-range transceivers, such as an infrared (IR) transceiver, a Bluetooth™ (BT) transceiver operating using Bluetooth™ wireless technology, a wireless universal serial bus (USB) transceiver, a Bluetooth™ Low Energy transceiver, a ZigBee transceiver, an ANT transceiver, a cellular device-to-device transceiver, a wireless local area link transceiver, and/or any other short-range radio technology. The communication device 200 and more specifically, the short-range transceiver may be capable of transmitting data to and/or receiving data from electronic devices within the proximity of the apparatus, such as within 10 meters, for example. The communication device 200 including the Wi-Fi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The communication device 200 may comprise memory, such as one or more Subscriber Identity Modules (SIM), one or more Universal Subscriber Identity Modules (USIM), one or more removable User Identity Modules (R-UIM), one or more eUICC, one or more UICC, and/or the like, which may store information elements related to a mobile subscriber. In addition, the communication device 200 may include other removable and/or fixed memory. The communication device 200 may include volatile memory and/or non-volatile memory. For example, the volatile memory may include Random Access Memory (RAM) including dynamic and/or static RAM, on-chip or off-chip cache memory, and/or the like. The non-volatile memory, which may be embedded and/or removable, may include, for example, read-only memory, flash memory, magnetic storage devices, for example, hard disks, floppy disk drives, magnetic tape, optical disc drives and/or media, non-volatile random-access memory (NVRAM), and/or the like. Like volatile memory, the non-volatile memory may include a cache area for temporary storage of data. At least part of the volatile and/or non-volatile memory may be embedded in the processor. The memories may store one or more software programs, instructions, pieces of information, data, and/or the like which may be used by the apparatus for performing operations disclosed herein.

The memories may comprise an identifier, such as an International Mobile Equipment Identification (IMEI) code, capable of uniquely identifying the communication device 200. The memories may comprise an identifier, such as an international mobile equipment identification (IMEI) code, capable of uniquely identifying the communication device 200. In the example embodiment, the processor may be configured using computer code stored at memory to cause the processor to perform operations disclosed herein.

Some of the embodiments disclosed herein may be implemented in software, hardware, application logic, or a combination of software, hardware, and application logic. The software, application logic, and/or hardware may reside on the memory, the processor, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as a computer or data processor circuitry, with examples depicted at FIG. 2, computer-readable medium may comprise a non-transitory computer-readable storage medium that may be any media that can contain or store the instructions for use by or in connection with an instruction execution system, apparatus, or device, such as a computer.

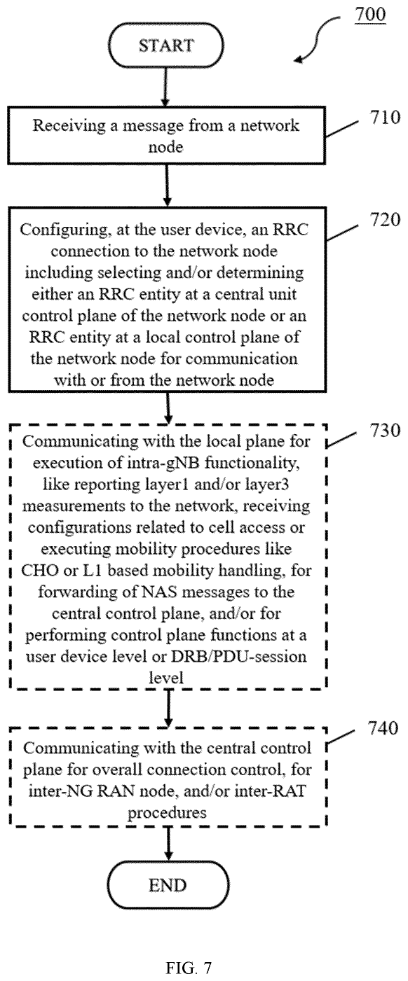

In some embodiments, the communication device 200 (i.e., a user equipment (UE) or a user device in a network) comprises the processor (e.g., the at least one data processing entity 201) and the memory (e.g., the at least one memory 202). The memory includes computer program code causing the communication device 200 to perform processing according to the methods described below with reference to FIG. 7.

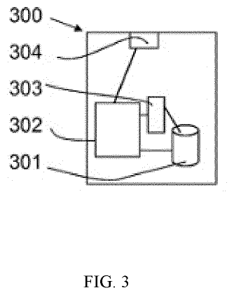

FIG. 3 shows an example embodiment of a control apparatus for a communication system, for example to be coupled to and/or for controlling a station of an access system, such as a RAN node, e.g., a base station, eNB or gNB, a relay node or a core network node such as an MME or S-GW or P-GW, or a core network function such as AMF/SMF, or a server or host. The method may be implanted in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head.

Generally, the control apparatus 300 has an antenna, which transmits and receives radio signals. A radio frequency (RF) transceiver module, coupled with the antenna, receives RF signals from antenna, converts them to baseband signals and sends them to processor (e.g., the at least one data processing unit 302, 303). RF transceiver also converts received baseband signals from processor, converts them to RF signals, and sends out to antenna. Processor processes the received baseband signals and invokes different functional modules to perform features in control apparatus 300. Memory (e.g., the at least one memory 301) stores program instructions and data to control the operations of the control apparatus 300. In the example of FIG. 3, the control apparatus 300 also includes protocol stack and a set of control functional modules and circuit. PDU session handling circuit handles PDU session establishment and modification procedures. Policy control module that configures policy rules for UEs. Configuration and control circuit provides different parameters to configure and control UEs of related functionalities including mobility management and session management. Suitable processors include, by way of example, a special purpose processor, a digital signal processor (DSP), a plurality of micro-processors, one or more micro-processor associated with a DSP core, a controller, a microcontroller, application specific integrated circuits (ASICs), file programmable gate array (FPGA) circuits, and other type of integrated circuits (ICs), and/or state machines.

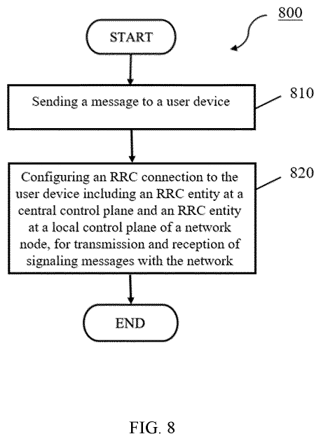

In some embodiments, the control apparatus 300 (i.e., a base station, a wireless transmitting and/or receiving point equipment, or a network node in a network) comprises the processor (e.g., the at least one data processing unit 302, 303) and the memory (e.g., the at least one memory 301). The memory includes computer program code causing the control apparatus 300 to perform processing according to the method described below with reference to FIG. 8.

As mentioned, network slicing is a concept where network resources of an end-to-end connection between a user device (i.e., a user equipment, UE) and another end point in a network such as a Public Land Mobile Network (PLMN) are sliced. Similar network slicing may be employed also in private networks. A network slice may be understood as a logical end-to-end network that can be dynamically created and/or modified. The network(s) between the end devices may all be sliced from one end device to the other end device, the slices thus forming logical pipelines within the network(s). User devices may access a slice over a radio interface. As described in 3GPP TS 38.300 (e.g., version 16.8.0 Release 16, 2022-01), network slicing is a key feature in 5G to support different services using the same underlying mobile network infrastructure.

Thus, network slicing enables a communications service provider to provide dedicated virtual networks over a common network infrastructure. The different virtual or logical networks may be designed to provide different networking characteristics such as different qualities of service (QoS) in order to host services with diverse requirements and service level agreements (SLAs). For example, the virtual networks may be customized to meet specific needs of various applications, services, devices, customers and/or operators. Thus, the network slicing enables provision of different services to the terminal device. In an example, network slices may differ either in their service requirements like URLLC and eMBB or the tenant that provides those services.

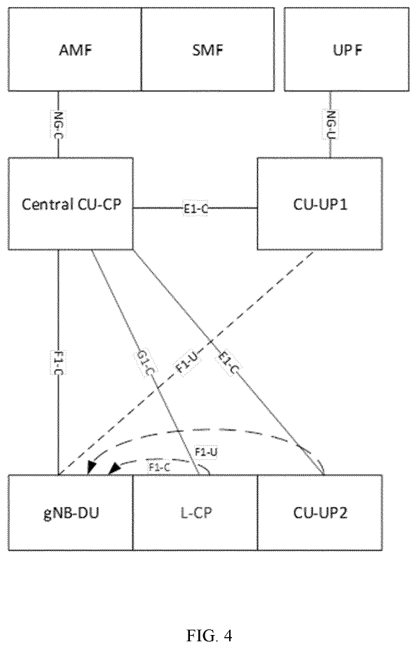

An illustration of an example disaggregated gNB architecture including a local control plane is provided by FIG. 4. In this disaggregated architecture, the gNB is decomposed into multiple logical entities. Such a disaggregated architecture is feasible for gNBs e.g., in 5G NR systems, for which the one or more first units may be represented by at least one distributed unit (DU) and the second unit may be represented by a centralized unit (CU). The CU may be further split into a CU Control Plane (CP) part, also referred to as CU-C or CU-CP, and a CU User Plane (UP) part, also referred to as CU-U or CU-UP. Such split enables the implementation of the CU-CP and CU-UP parts in different locations. A DU may host multiple cells (max of 512 in current specifications). The CU-CP hosts one or more gNB-DUs and one or more CU-UP. There can be only one CU-CP in a gNB. The PDCP-C (control plane part) and RRC layers are in CU-CP, while the gNB-DU hosts the RLC/, MAC and PHY layers. The scheduling operation takes place at the gNB-DU. The CU-UP hosts the PDCP-U (user plane part) and SDAP protocols.

The disaggregated gNB architecture introduces F1 interfaces between the gNB-DU(s) and the CU-UP(s) and the CU-CP. E1 interfaces are provided between the CU-CP and the CU-UP(s). In this example, a central CU-CP is present with two CU-CP1 and CU-CP2. One gNB-DU is provided at the gNB. The gNB has an interface NG-C from the central CU-CP to network control functions like e.g., Access and Mobility Management Function (AMF) and Session Management Function (SMF). Further, the gNB has an interface NG-U from the CU-UP(s) to network user functions like e.g., a User Plane Function (UPF).

The disaggregated gNB architecture further includes a local control plane (L-CP) network entity that hosts an additional RRC entity for a UE which is in addition to the existing RRC entity at CU-CP. The L-CP may handle the “local” mobility functions of the UE e.g., forwarding of NAS messages to CU-CP and intra-gNB CHO/L1-based mobility operation, and is assigned with its own UE identity which may include RRC handling for selected UEs. This may include performing L-CP functions at a UE level or DRB/PDU-session level. This may allow for transferring some of the CU-CP tasks (such as L1 mobility) related to RRC to the L-CP, while maintaining the overall connection control at CU-CP and thus can be completely transparent to the CN. Additionally, this may require that the RRC message and/or the PDCP layer indicates the RRC entity to the UE to enable (de)ciphering the RRC message with the right security key.

The local control plane (L-CP) entity complies to the RAN3 cardinality agreed in 3GPP, i.e., gNB-CU-CP remains a singleton in a gNB.

A UE may maintain a single RRC connection, terminated at the CU-CP, but can be assigned with two RRC entities i.e., one RRC entity at the CU-CP and one RRC entity at the L-CP. The single RRC Connection may be signified by the addressing and identifiers associated with the connection.

The NG-C/U interface may be terminated only at the CU-CP and the CU-UP respectively i.e., the L-CP is transparent to the CN and only the CU is aware of its existence.

The selection of C-plane RRC handling per UE (CU-CP or L-CP) may be performed by the CU-CP. This may be based on UE capability e.g., type of UE like robot, sensor etc., on AI-ML based algorithms using UE history to determine mobility scope of UE, Femto UEs with limited mobility, Factory UEs etc.

The L-CP may be introduced with at least the following functionalities: RRC handling for selected UEs, which may include performing L-CP selection functions at a UE level or DRB/PDU-session level; forwarding of NAS messages to the CU-CP; and/or local mobility handling e.g., CHO/L1 based mobility.

The L-CP may communicate with CU-CP via a network interface G1-C. G1-C may be an interface on an SCTP connection like other RAN3 interfaces. Hence, the same security mechanisms apply here as well. RRC messages from a UE may be routed from gNB-DU over the interface F1-C to the CU-CP. Accordingly, all NG-C specific procedures may be handled by CU-CP, also for those UEs whose RRC handling is performed at L-CP. The RRC state of the UE may be decided by CU-CP i.e., the RRC anchoring point never changes inside a gNB, and L3 HO requests are handled by CU-CP.

Initial selection of the c-plane entity for a given UE may be done by CU-CP and notified to the L-CP, if selected. Subsequently, all NAS messages from the UE are routed through CU-CP to the core network (CN) i.e., AMF or equivalent of it.

The CU-CP may control and handle all inter-gNB procedures e.g., configures and receives measurements related to inter-gNB HOs, inter-RAT HOs, Dual Connectivity etc. the CU-CP may synchronize with the L-CP after/during inter-gNB procedures e.g., UE context release. The L-CP may co-ordinate/notify with the CU-CP before or after events e.g., CHO, lower Layer mobility, inter-DU HO, Carrier aggregation etc. The CU-CP may fetch the latest UE RRC configuration from the L-CP while initiating inter-gNB procedures or alternatively, the L-CP can sync with the CU-CP after completion of each RRC procedure.

The UE context may reside in both the CU-CP and the L-CP. Each context may have different content and parameters to differentiate between the two contexts, but to identify the same UE. Alternatively, the UE context may be stored in a RAN data base (DB) and can be accessed (authorized to) by both the CU-CP and the L-CP. The UE's RRC state may be decided by the CU-CP, hence the UE context read/write to RAN DB during RRC state transition is performed by the CU-CP. This may involve the CU-CP retrieving the UE context information from the L-CP before storing in the RAN DB. However, a stateless C-plane in CONNECTED mode may be implemented as well. In such cases, the L-CP may also be enabled to read-write UE context from/to the RAN-DB.

Regarding security handling both the CU-CP and the L-CP may be complemented with their own PDCP-C for ciphering and integrity protection. The main Access Stratum security key materials (KgNB, Krrcint, Krrcenc etc) may be stored in the CU-CP. The CU-CP may derive another set of keys for the protection of RRC messages between the UE and the L-CP and may send it to the L-CP entity. The UE may also derive the same key materials for the L-CP upon a message from the CU-CP.

The L-CP may be selected considering the slice support. Multi-slice UEs may be associated with multiple L-CPs considering the slice SLAs. Slice support information and slice-related parameters e.g., slice load may be exchanged over the interface between the L-CP and the CU-CP i.e., G1-C.

The UE may receive RRC messages from the same gNB from two different entities i.e., the CU-CP and the L-CP. The source/destination i.e., UE to CU-CP, UE to L-CP, CU-CP to UE, L-CP to UE etc. may be indicated in the RRC messages. Based on this information available in the RRC message header, the UE may select the appropriate key from the stored key set and correspondingly use to encrypt/decrypt or integrity protect/verify the messages. This configuration may be shared by the CU-CP in the first RRC Reconfiguration message. The PDCP-C header may indicate the RRC entity to the UE to enable (de)ciphering the RRC message with the right security key. The UE may use the same indication in UL RRC messages also. This enables the gNB-DU to remember and identify the owner of an UL RRC message and also deliver the received UL RRC messages to the right C-plane entity in the network i.e., the CU-CP or the L-CP.

The local control plane L-CP may be merged inside the gNB-DU i.e., L-CP functionality is not separate from the gNB-DU.

local control plane L L-CP may be implemented in accordance with (micro) service-based architecture (SBA) principles in which the L-CP can be defined as or include a collection of services that are exposed and discoverable by other authorized functions in the network through service-based interfaces (SBI) with associated application programming interfaces (APIs).

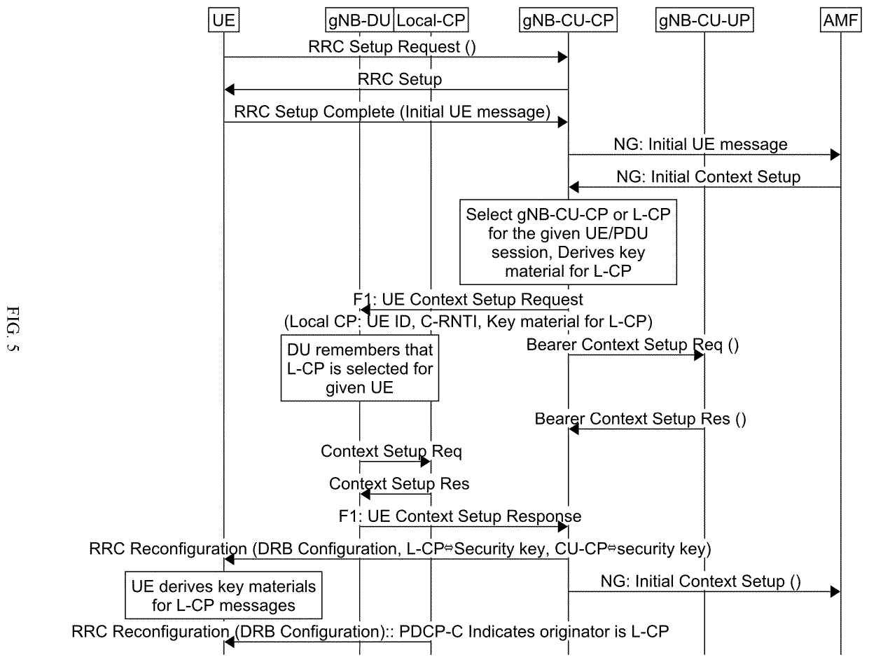

FIG. 5 illustrates an example message sequence diagram for RRC connection setup.

In the example scenario, the user device (e.g., UE) is assumed to be connecting to a cell in which a gNB like depicted in FIG. 4 is present. As mentioned before, the gNB includes a gNB-DU, a CU-CP, a L-CP and a CU-UP. The gNB is connected to the AMF.

For RRC connection setup, the UE is sending an RRC setup request to the CU-CP of gNB which is replied to with an RRC setup message. In response, the UE indicates RRC setup complete to the CU-CP including an initial UE message The gNB sends the Initial UE Message to the selected AMF. The message carries the “Registration Request” message received from the UE in the RRC Setup Complete message.

In response, the AMF indicates the initial context setup to the CU-CP. At the CU-CP, the CU-CP or the L-CP is selected for a UE session. Further, security key material is derived for the L-CP. Via the F1 interface, the CU-CP sends a UE context setup request to the gNB-DU. This request includes a UE ID, a control Radio Network Temporary Identifier (C-RNTI) and the security key material for the L-CP.

The gNB-DU stores that the L-CP is selected for this UE and runs the context setup with the L-CP. After that, the gNB-DU sends to the CU-CP a UE context setup response indicating that the setup is finished. In between, the CU-CP had run the bearer context setup with the CU-UP.

Then, the CU-CP sends an RRC reconfiguration message to the UE. This message includes the data radio bearer configuration as well as security material e.g., one or more keys for the L-CP and for the CU-CP. The UE derives upon receipt of this message key materials for messages to and from the L-CP.

Further, the L-CP sends an RRC reconfiguration message to the UE indicating that the Packet Data Convergence Protocol (PDCP) originates from L-CP. In between, the CU-CP had sent an initial context setup message to the AMF indicating that the setup is completed.

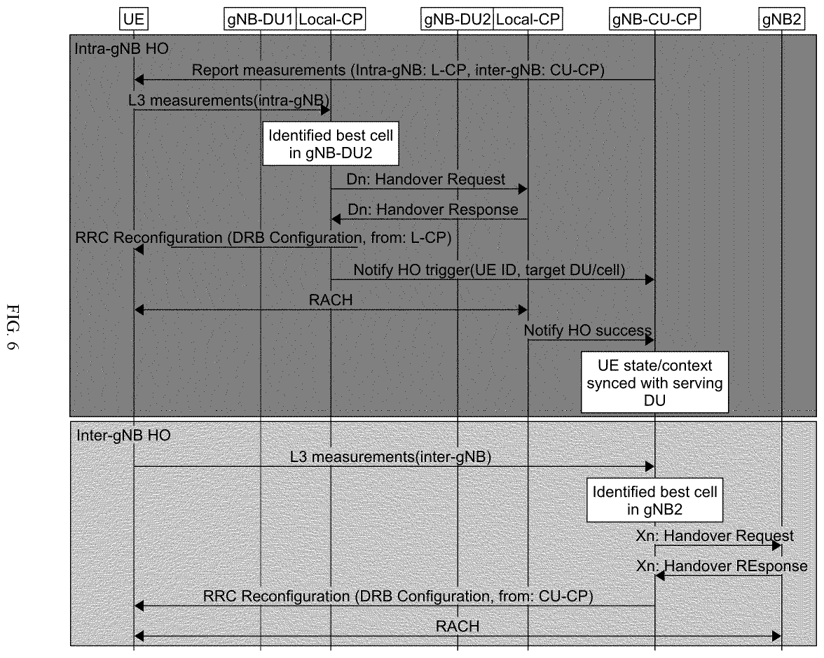

In FIG. 6, an example message sequence diagram for intra and inter-gNB hand over is illustrated.

In the example scenario, the user device (e.g., UE) is assumed to be connected to a cell in which a gNB like for example depicted in FIG. 4 is present. The UE is connected to a cell in gNB-DUI in this example. As mentioned before, the gNB1 includes a first gNB-DU1, a second gNB-DU2, each with a respective L-CP and a common CU-CP. The gNB is connected to the AMF. A second gNB2 is also present. The second gNB2 may have the same structure like the gNB1.

First, the intra-gNB hand over depicted in the top portion of FIG. 6 is discussed. The CU-CP allows measurements to the UE which are to be reported to L-CP of gNB-DU1. The UE conducts layer 3 (L3) measurements and sends a measurement report message to the L-CP of gNB-DU1. This message may include the serving cell and neighboring cell signal strength. In this example, the L-CP of gNB-DUI identifies the best cell in gNB-DU2 and sends accordingly, a handover request to the L-CP of gNB-DU2. The L-CP of gNB-DU2 sends a handover response. An identification of whether a measured cell is an intra or inter-gNB cell may be possible by broadcasting an identifier in SIB or broadcasting a unique value in the CSI-RS.

The L-CP of gNB-DU1 sends an RRC reconfiguration message to the UE. This message includes the data radio bearer configuration as well as an indication that the message origins from the L-CP. Further, the L-CP of gNB-DUI sends a notify HO trigger to the CU-CP including the UE ID and the target DU/cell. Then, the Random Access Channel (RACH) is setup between the UE and the L-CP of gNB-DU2. Thereafter, the L-CP of gNB-DU2notifies HO success to the CU-CP. As a last step, the CU-CP synchronizes the UE state and context with the serving DU i.e., gNB-DU2 in this example.

For Intra-gNB HO, handover preparation may be performed over a DU-DU interface. Source and target DU may notify the CU-CP to keep synchronization between the network states. Inter-working between mobility procedures controlled by CU-CP and L-CP may be provided to ensure that collisions are avoided. All intra-gNB procedures and mobility events may be handled using the L-CP: Intra-gNB CHO, Lower layer mobility, Carrier aggregation (including setup/Scell addition/release etc.), Multi-TRP operation, and/or DRX, in co-ordination with CU-CP.

Second, the inter-gNB hand over depicted in the bottom portion of FIG. 6 is discussed. The CU-CP allows measurements to the UE which are to be reported to the CU-CP of gNB1.

The UE conducts layer 3 (L3) measurements and sends a measurement report message to the CU-CP of gNB1. This message may include the serving cell and neighboring cell signal strength. In this example, the CU-CP of gNB1 identifies the best cell in gNB2 and sends accordingly, a handover request to the gNB2. The gNB2 sends a handover response.

The CU-CP of gNB1 sends an RRC reconfiguration message to the UE. This message includes the data radio bearer configuration as well as an indication that the message origins from the CU-CP. As a last step, the Random Access Channel (RACH) is setup between the UE and the gNB2.

In both cases of FIG. 6, the data path establishment with the target gNB-DU may be performed by the source gNB-DU notifying the gNB-CU-CP (after Handover preparation) over F1-C and the gNB-CU-CP notifying the gNB-CU-UP about the new DL TEID details.

FIG. 7 illustrates an example flow chart of a method for controlling a user device in a network. The method depicted in FIG. 7 illustrates configuring an RRC connection to the network node by selecting either an RRC entity at a central unit control plane of the network node or an RRC entity at a local control plane of the network node. For ease of reading the central unit control plane may also be referred to as a central control plane.

The method may be performed by a user device (also referred to as a user equipment (UE)), or an apparatus for use in a user device. For example, the UE may be represented by any one of the mobile communication devices 102, 104, 105 of the wireless communication system 100 as described above with reference to FIG. 1, or the communication device 200 as described above with reference to FIG. 2.

In an example, the network may comprise one or more network nodes (e.g., one or more base stations like depicted in FIG. 4) and at least one user device (UE like depicted in FIG. 2).

At block 710, the user device receives a message from a network node.

The message may be an RRC message including an indication of the RRC entity to be selected, wherein the indication of the RRC entity to be selected may be based on the type and/or capabilities of the user device. When sending UL messages, the UE or user device may include the indication in UL RRC messages.

At block 720, the user device configures an RRC connection to the network node including selecting and/or determining either an RRC entity at a central control plane of the network node or an RRC entity at a local control plane of the network node for communication with or from the network node.

The user device may receive RRC messages from the central control plane and the local control plane of the network node.

In some examples, the method 700 may further comprise, at block 730, communicating with the local control plane for execution of intra-gNB functionality, like reporting layer1 and/or layer3 measurements to the network, receiving configurations related to cell access or executing mobility procedures like CHO or L1 based mobility handling, for forwarding of NAS messages to the central control plane, and/or for performing control plane functions at a user device level or DRB/PDU-session level.

In some other examples, the method 700 may further comprise, at block 740, communicating with the central control plane for overall connection control, for inter-NG RAN node, and/or inter-RAT procedures.

In some further examples, the method 700 may further comprise, selecting, by the user device, based on the indication a key from a stored key set; and using, by the user device, the key to encrypt/decrypt or integrity protect/verify communication to/from the network node.

In some further examples, the method 700 may further comprise, receiving an indication, from a network node, on provision of multiple local control planes for slice support; and sending, to the network node, an association of the user device with one or more of the multiple local control planes according to slice services.

FIG. 8 illustrates an example flow chart of a method for controlling a network device in a network. The method is performed by the network. More specifically, the method may be performed by one or more network nodes or network functions of the network, or an apparatus for use in a network node or by a network function. For example, the method may be performed by a base station such as the base station represented by the control apparatus 300 as described above with reference to FIG. 3, a gNB as described above with reference to FIG. 4 and/or a core network function such as AMF.

As already discussed above, in an example, the network may comprise one or more network nodes (e.g., one or more base stations like depicted in FIG. 4) and at least one user equipment (UE like depicted in FIG. 2).

At block 810, the network device sends a message to a user device.

The message may be an RRC message including an indication of the RRC entity to be selected, wherein the indication of the RRC entity to be selected may be based on the type and/or capabilities of the user device. The RRC messages may be sent to the user device from the central control plane and/or the local control plane of the network node.

At block 820, the network device configures an RRC connection to the user device including an RRC entity at a central control plane and an RRC entity at a local control plane of a network node, for transmission and reception of signaling messages with the network.

The local control plane may be provided for a single user device. So that several local control planes may be provided in case of several user devices. The local control plane may provide RRC functionality, like CHO or L1 based mobility handling, forwarding of NAS messages to the central control plane, and/or performing control functions at a user device level or DRB/PDU-session level. The central control plane may provide overall connection control and/or inter-node procedures.

In some examples, the method 800 may further comprise, terminating, by the central control plane only, a network node control interface and/or deciding, by the central control plane only, on an RRC state of the user device.

In some examples, the method 800 may further comprise, storing context of the user device in a RAN data base and/or storing context of the user device in the central control plane and/or the local control plane. The latter may include storing or reading, by the local control plane, context of the user device to or from a RAN data base.

In some examples, the method 800 may further comprise, providing multiple local control planes for slice support; and receiving, from the user device, an association of the user device with one or more of the multiple local control planes according to slice services. Even further, the method 800 may further comprise, exchanging slice support information and/or slice-related parameters over an interface between the central control plane and/or the local control plane.

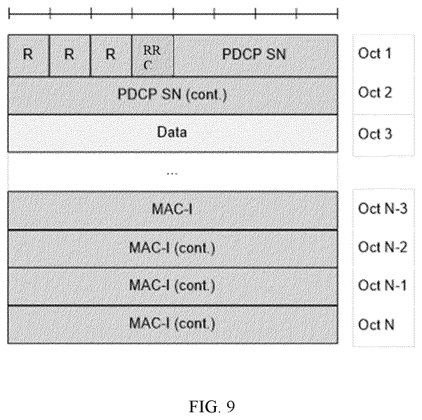

FIG. 9 illustrates an example PDCP protocol data unit for a Signaling Radio Bearer (SRB) and shows the format of the PDCP Data PDU with 12 bits PDCP SN. This format is applicable for SRBs.

For ciphering and de-ciphering purposes, the PDCP PDU containing the SRB message coming from L-CP may also indicate this in the PDCP header as shown in FIG. 9. This indication of origin may be added to existing PDCP specification TS 38.323.

An RRC field with a length of 1 bit indicates whether the contained RRC messages originates from L-CP. This may be used for ciphering purposes. A bit value of 0 may indicate that the contained RRC message originates from CU-CP. A bit value of 1 may indicate that the contained RRC message originates from L-CP.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to LTE and 5G NR, similar principles can be applied in relation to other networks and communication systems where enforcing fast connection re-establishment is required. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes exemplary embodiments, there are several variations and modifications which may be made to the disclosed solution without departing from the scope of the subject disclosure.

In general, the various exemplary embodiments may be implemented in hardware or special purpose circuits, software, logic or any combination thereof. Some aspects of the subject disclosure may be implemented in hardware, while other aspects may be implemented in firmware or software which may be executed by a controller, microprocessor or other computing device, although the subject disclosure is not limited thereto. While various aspects of the subject disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Example embodiments of the subject disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may comprise one or more of general-purpose computers, special purpose computers, microprocessors, digital signal processors (DSPs), application specific integrated circuits (ASICs), FPGA, gate level circuits and processors based on multi-core processor architecture, as non-limiting examples.

Example embodiments of the subject disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of the subject disclosure. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of the subject disclosure as defined in the appended claims. Indeed, there is a further embodiment comprising a combination of one or more embodiments with any of the other embodiments previously discussed.

1-35. (canceled)

36. A method of controlling a user device in a communications network, comprising:
receiving a message from a network node;
configuring, at the user device, an RRC connection to the network node including selecting and/or determining either an RRC entity at a central unit control plane of the network node or an RRC entity at a local control plane of the network node for communication with or from the network node.

37. The method according to claim 36, further comprising:
selecting, by the user device, based on the indication a key corresponding to the selected RRC entity from a stored key set; and
using, by the user device, the key to encrypt/decrypt or integrity protect/verify communication to/from the network node.

38. The method according to claim 36, wherein the message is a downlink RRC message including an indication of the RRC entity to select.

39. The method according to claims 38, wherein a similar or identical indication is included in UL RRC messages sent by the user device.

40. The method according to claim 36, further comprising:
communicating with the local control plane for execution of intra-gNB functionality, like reporting layer1 and/or layer3 measurements to the network, receiving configurations related to cell access or executing mobility procedures like CHO or L1 based mobility handling, for forwarding of NAS messages to the central control plane, and/or for performing control plane functions at a user device level or DRB/PDU-session level.

41. The method according to claim 36, further comprising:
communicating with the central control plane for overall connection control, for inter-NG RAN node, and/or inter-RAT procedures.

42. The method according to claim 36, wherein the user device can receive RRC messages from the central unit control plane and/or the local control plane of the network node as part of the same RRC connection.

43. The method according to claim 36, further comprising:
receiving an indication, from a network node, on provision of multiple local control planes for slice support; and
sending, to the network node, an association of the user device with one or more of the multiple local control planes according to slice services.

44. A user device, comprising:
at least one processor; and at least one memory storing instructions that, when executed by the at least one processor, cause the user device at least to perform:
receiving a message from a network node;
configuring an RRC connection to the network node including selecting and/or determining either an RRC entity at a central unit control plane of the network node or an RRC entity at a local control plane of the network node for communication with or from the network node.

45. The user device according to claim 44, wherein the user device is further caused to:
selecting, by the user device, based on the indication a key corresponding to the selected RRC entity from a stored key set; and
using, by the user device, the key to encrypt/decrypt or integrity protect/verify communication to/from the network node.

46. The user device according to claim 44, wherein the message is a downlink RRC message including an indication of the RRC entity to select.

47. The user device according to claim 46, wherein a similar or identical indication is included in UL RRC messages sent by the user device.

48. The user device according to claim 44, wherein the user device is further caused to perform:
communicating with the local control plane for execution of intra-gNB functionality, like reporting layer1 and/or layer3 measurements to the network, receiving configurations related to cell access or executing mobility procedures like CHO or L1 based mobility handling, for forwarding of NAS messages to the central control plane, and/or for performing control plane functions at a user device level or DRB/PDU-session level.

49. The user device according to claim 44, wherein the user device is further caused to perform:
communicating with the central control plane for overall connection control, for inter-NG RAN node, and/or inter-RAT procedures.

50. The user device according to claim 44, wherein the user device can receive RRC messages from the central unit control plane and/or the local control plane of the network node as part of the same RRC connection.

51. The user device according to claim 44, wherein the user device is further caused to perform:
receiving an indication, from a network node, on provision of multiple local control planes for slice support; and
sending, to the network node, an association of the user device with one or more of the multiple local control planes according to slice services.

52. A network device, comprising:
at least one processor; and at least one memory storing instructions that, when executed by the at least one processor, cause the network device at least to perform: receiving a message from a user device;
configuring an RRC connection to the user device including an RRC entity at a central control plane and an RRC entity at a local control plane of a network node, for transmission and reception of signaling messages with the network.

53. The network device according to claim 52, wherein the message is a downlink RRC message including an indication of the RRC entity to be selected for communication with the network.

54. The network device according to claim 53, wherein the indication of the RRC entity to be selected is based on the type and/or capabilities of the user device and services invoked.

55. The network device according to claim 54, wherein the local control plane is configured per a single user device or per a group of user devices like a Virtual Network, VN group.
